(19) United States
(12) Patent Application Publication
(10) Pub. No.: US 2014/0120846 A1
(43) Pub. Date: May 1, 2014

(54) MIXER

(71) Applicant: VIA Telecom, Inc., San Diego, CA (US)

(72) Inventors: Bing-Jye Kuo, New Taipei City (TW); Hsien-Ku Chen, New Taipei City (TW)

(73) Assignee: VIA Telecom, Inc., San Diego, CA (US)

(21) Appl. No.: 14/066,699

(22) Filed: Oct. 30, 2013

(30) Foreign Application Priority Data
Oct. 30, 2012 (CN) 201210424371.3

(51) Int. Cl. H04B 1/40

(52) U.S. Cl. CPC H04B 1/40
USPC 455/73

(57) ABSTRACT

A mixing unit includes a baseband signal processing unit, a radio frequency (RF) signal processing unit and a mixing unit. The baseband signal processing unit receives or generates a baseband signal. The RF signal processing unit processes or outputs a RF signal. The mixing unit is coupled to the baseband signal processing unit and the RF signal processing unit to select and operate in an up-convert mode or a down-convert mode according to a control signal. When the mixer operates in an up-convert mode, the mixing unit mixes the baseband signal with a local oscillation signal to generate the RF signal and outputs the RF signal to the RF signal processing unit. When the mixer operates in a down-convert mode, the mixing unit mixes the RF signal with the local oscillation signal to generate the baseband signal and outputs the baseband signal to the baseband signal processing unit.

### CROSS-REFERENCE TO RELATED APPLICATION

This application claims the priority benefit of China application serial no. 201210424371.3, filed on Oct. 30, 2012. The entirety of the above-mentioned patent application is hereby incorporated by reference herein and made a part of this specification.

### BACKGROUND OF THE INVENTION

1. Field of the Invention

The present invention relates to a mixer, more particularly to a mixer having a signal mixing unit capable of performing both an up-convert mixing and a down-convert mixing.

2. Description of Related Art

Regardless of whether to transmit or receive a radio frequency signal, a mixer is needed for the communication device to perform mixing processes to the radio frequency signal. For example, an intermediate frequency signal may be up-converted to radio frequency signal with a higher carrier frequency, or a radio frequency signal received by an antenna may be down-converted to an intermediate frequency signal or a baseband signal, so as to facilitate subsequent signal processes. For instance, while transmitting a baseband signal generated by a signal source of a baseband signal processing unit, the baseband signal is first being mixed with a local oscillation signal, such that the baseband signal may be up-converted to a radio frequency signal. Next, said radio frequency signal may be transmitted to a device such as a power amplifier for amplification or said radio frequency signal may be transmitted directly to an antenna for transmission. On the other hand, once the radio frequency signal has been received by the antenna, the radio frequency signal and the local oscillation signal may be mixed by a down converter to down-convert the radio frequency signal to an intermediate frequency signal or a baseband signal, such that the subsequent signal processes of the baseband signal may be performed by, for example, a baseband signal unit.

Generally, an up-convert mixer and a down-convert mixer are usually implemented by two different sets of circuit components. Said two sets of the mixers usually occupy a rather larger circuit area and each respectively receives an oscillator signal from a local terminal. As a result, a local oscillator usually has higher power dissipation.

### SUMMARY OF THE INVENTION

In view of above, the present invention is directed to a mixer having a signal mixing unit capable of performing both an up-convert mixing and a down-convert mixing, so as to effectively reduce circuit area of a communication device and overall manufacturing costs thereof.

According to an embodiment of the invention, a mixer is provided. The mixing unit includes a baseband signal processing unit, a radio frequency signal processing unit and a mixing unit. The baseband signal processing unit is configured to receive or generate a baseband signal. The radio frequency signal processing unit is configured to process or output a radio frequency signal. The mixing unit is coupled to the baseband signal processing unit and the radio frequency signal processing unit and configured to select and operate in an up-convert mode or a down-convert mode according to a control signal. In addition, when the mixer operates in an up-convert mode, the mixing unit mixes the baseband signal with a local oscillation signal to generate the radio frequency signal and outputs the radio frequency signal to the radio frequency signal processing unit. Further, when the mixer operates in a down-convert mode, the mixing unit mixes the radio frequency signal with the local oscillation signal to generate the baseband signal and outputs the baseband signal to the baseband signal processing unit.

According to another embodiment of the invention, a mixer is provided. The mixer includes a baseband signal processing unit, a radio frequency signal processing unit, a first differential pair and a second differential pair. The first differential pair and the second differential pair are respectively coupled to the baseband signal processing unit and the radio frequency signal processing unit and configured to perform an up-convert mixing process or a down-convert mixing process according to a control signal. In addition, when the mixer operates in an up-convert mode, the first and the second differential pairs perform a up-convert mixing process to collectively mix the baseband signal with a local oscillation signal to generate the radio frequency signal and outputs the radio frequency signal to the radio frequency signal processing unit. In addition, when the mixer operates in a down-convert mode, the first and the second differential pairs perform a down-convert mixing process to collectively mix the radio frequency signal with the local oscillation signal to generate the baseband signal and outputs the baseband signal to the baseband signal processing unit.

In view of above, according to the embodiments of the invention, which provides a mixer having a single mixing unit for switching to an up-convert mode or a down-convert mode according to a control unit outside of the communication device where the mixer is located. When the mixer operates in the up-convert mode, the mixing unit may perform an up-convert mixing to a baseband signal and a local oscillation signal outputted from a baseband signal processing unit, so as to up-convert the baseband signal to a radio frequency signal, and the radio frequency signal is outputted to a radio frequency signal processing unit of a next stage for subsequent processes. When the mixer operates in the down-convert mode, the mixing unit may perform a down-convert mixing to a radio frequency signal and a local oscillation signal outputted from a radio frequency signal processing unit, so as to down-convert the radio frequency signal to a baseband signal, and the baseband signal is outputted to a baseband signal processing unit of a next stage for subsequent processes. Since the same mixing unit is used for both up-convert mixing and down-convert mixing, circuit area occupied by the mixer and manufacturing costs may both be reduced.

To make the above features and advantages of the invention more comprehensible, several embodiments accompanied with drawings are described in detail as follows.

### BRIEF DESCRIPTION OF THE DRAWINGS

FIG. 1 is a block diagram illustrating a mixer according to an embodiment of the invention.

FIG. 2A is a schematic view illustrating a mixer operating in an up-convert mode according to an embodiment of the invention.

FIG. 2B is a schematic view illustrating a mixer operating in a down-convert mode according to an embodiment of the invention.

FIG. 3 is a schematic view illustrating a mixer according to an embodiment of the invention.

FIG. 4A is a schematic view illustrating a mixer operating in a down-convert mode according to an embodiment of the invention.

FIG. 4B is a schematic view illustrating a mixer operating in an up-convert mode according to an embodiment of the invention.

FIG. 5 is a block diagram illustrating a mixer according to an embodiment of the invention.

FIG. 6 is a block diagram illustrating a mixer according to an embodiment of the invention.

FIG. 7 is a schematic view illustrating a mixer according to an embodiment of the invention.

### DESCRIPTION OF THE EMBODIMENTS

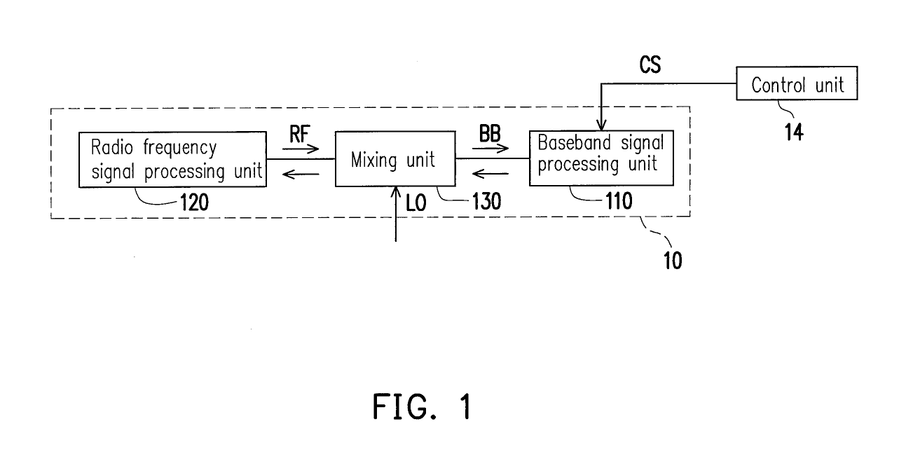

FIG. 1 is a block diagram illustrating a mixer according to an embodiment of the invention. Referring to FIG. 1, a mixing unit 10 includes a baseband signal processing unit 110, a radio frequency signal processing unit 120 and a mixing unit 130. The baseband signal processing unit 110 is configured to receive or generate a baseband signal BB. The radio frequency signal processing unit 120 is configured to process or output a radio frequency signal RF. The mixing unit 130 is coupled to the baseband signal processing unit 110 and the radio frequency signal processing unit 120 and configured to select and operate in an up-convert mode or a down-convert mode according to a control signal CS. In short, according to the embodiments of the invention, a signal mixer component merged by an up converter and a down converter of conventional art is provided, and a control unit may be used to switch said single mixer component to operate in the up-convert mode or the down-convert mode.

The control signal CS may be transmitted to the baseband signal processing unit 110 by a control unit 14 (i.e., corresponding to a control unit outside of the mixer 10) of a communication device (not illustrated) where the mixer 10 is disposed. The control unit 14 switches operations of components within the mixer 10 corresponding to current transmitting/receiving operation of a communication system. The control unit 14 may include a component capable of determining whether the communication system is in a transmitting state or a receiving state, such that the control signal CS may be correspondingly transmitted according to the transmitting/receiving state, but implementation of the invention is not limited thereto. The control unit 14 may also receive a result determined by an upper protocol layer of a communication protocol stacking unit to generate the control signal CS, such that the mixer 10 may be switched to operate in the up-convert mode or the down-convert mode.

The control signal CS may correspondingly switch the operating modes of the mixer 10 based on a predetermined time sequence. For instance, when the mixer 10 is applied in a communication device (such as a cell phone or a base station) using time division duplex (TDD), transmitting/receiving process in said communication device in each time slot is performed according to a predetermined schedule. Therefore, the control signal CS may switch the mixer 10 to operate in the up-convert mode/down-convert mode according to the transmitting/receiving process in each time slot of the communication device.

Referring back to FIG. 1, when the mixing unit 130 is switched to the up-convert mode by the control signal CS, the mixing unit 130 may mix the received baseband signal BB with a local oscillation signal LO to generate the radio frequency signal RF, and the radio frequency signal RF is outputted to the radio frequency signal processing unit 120. The local oscillation signal LO is generated by an oscillating unit (not illustrated in FIG. 1) of a radio frequency front-end circuit of the communication device where the mixer 10 is disposed, the related technical content is omitted herein. On the other hand, when the mixing unit 130 is switched to the down-convert mode by the control signal CS, the mixing unit 130 may mix the received radio frequency signal RF with the local oscillation signal LO to generate the baseband signal BB, and the baseband signal BB is outputted to the baseband signal processing unit 110.

Since the mixer 10 is characterized to have a capability of operating in up-convert mode/down-convert mode, the baseband signal processing unit 110 and the radio frequency signal processing unit 120 may respectively include a component for simultaneously transmitting and receiving a corresponding signal, in which the operation of the components may be switched according to the operating mode of the mixer 10.

For instance, the baseband signal processing unit 110 may simultaneously includes a signal generating unit (not illustrated in FIG. 1) to generate the baseband signal and a signal processing unit (not illustrated in FIG. 1) corresponding to the baseband signal used to process the received radio frequency signal. Further, when the mixer 10 operates in the up-convert mode, the baseband signal processing unit 110 may up-convert the baseband signal outputted from the baseband signal generating unit to the radio frequency signal via the mixing unit 130. When the mixer 10 operates in the down-convert mode, the baseband signal processing unit 110 may perform subsequent signal processes to the baseband signal (generated by down-converting the radio frequency signal with the mixer) via corresponding baseband signal processing components.

On the other hand, the radio frequency signal processing unit 120 may include a bandpass filter to perform a filter process to the radio frequency signal received by an antenna unit (not illustrated) and/or a low noise amplifier (LNA) to perform a gain process to the received radio frequency signal. However, the implementation of the invention is not limited thereto. The radio frequency signal processing unit 120 may also include a power amplifier (PA) to perform a signal amplification to the radio frequency signal to be transmitted. Further, when the mixer 10 operates in the up-convert mode, the radio frequency signal processing unit 120 may transmit the radio frequency signal outputted from the mixer 10 via the antenna, or perform subsequent processes to the radio frequency signal outputted by the mixer 10. In addition, when the mixer 10 operates in the down-convert mode, the radio frequency signal processing unit 120 may perform processes such as a filter process of the band-pass filter and/or a signal gain process of the low noise amplifier to the radio frequency signal received by the antenna unit, and down-convert said radio frequency signal to the baseband signal through the mixing unit 130, followed by performing subsequent processes through the baseband signal processing unit 110.

It should be noted that, operations of devices for transmitting/receiving included in the baseband signal processing unit 110 and the radio frequency signal processing unit 120 may be switched according to the control signal CS. For instance, when the control signal CS switches the mixer 10 to operate in the up-convert mode, a baseband signal generating component in the baseband signal processing unit 110 is enabled, and a corresponding component in the baseband signal processing unit 110 for receiving the baseband signal is disabled. On the other hand, when the control signal CS switches the mixer 10 to operate in the down-convert mode, the corresponding component in the baseband signal processing unit 110 for receiving the baseband signal is enabled, and the baseband signal generating unit in the baseband signal processing unit 110 is disabled. Persons skilled in the art should understand that the components included in the baseband signal processing unit 110 and the radio frequency signal processing unit 120 used for generating signal/transmitting signal/receiving signal/processing signal are simply taken as examples, the implementation of the invention is not limited thereto.

Since the mixer 10 may select and operate in the up-convert mode and the down-convert mode according to the signals generated from the baseband signal processing unit 110 and the radio frequency signal processing unit 120, such that the communication device where the mixer 10 is disposed does not need to use different mixer components when transmitting signal and receiving signal to complete operations such as an up-convert mixing and a down-convert mixing, thereby reducing overall circuit area and related manufacturing costs.

In addition, the radio frequency signal processing unit 120 may further include a radio frequency circuit load such as a LC tank. With proper circuitry design, the mixer 10 may use the same set of radio frequency circuit load when operating in the up-convert mode and the down-convert mode, so as to further reduce overall circuit area required and manufacturing costs.

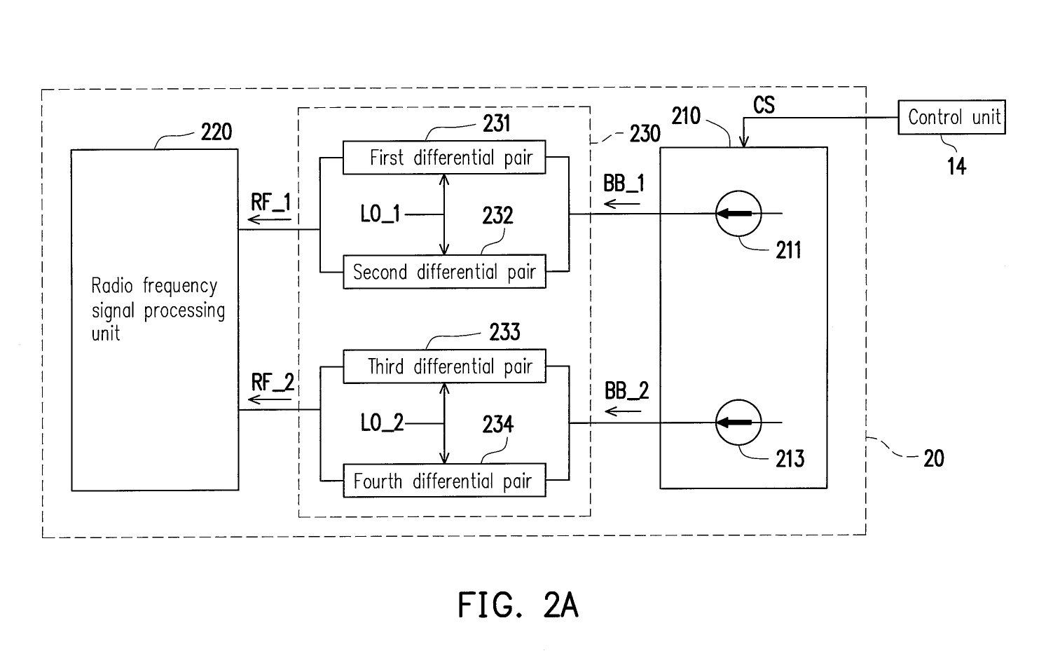

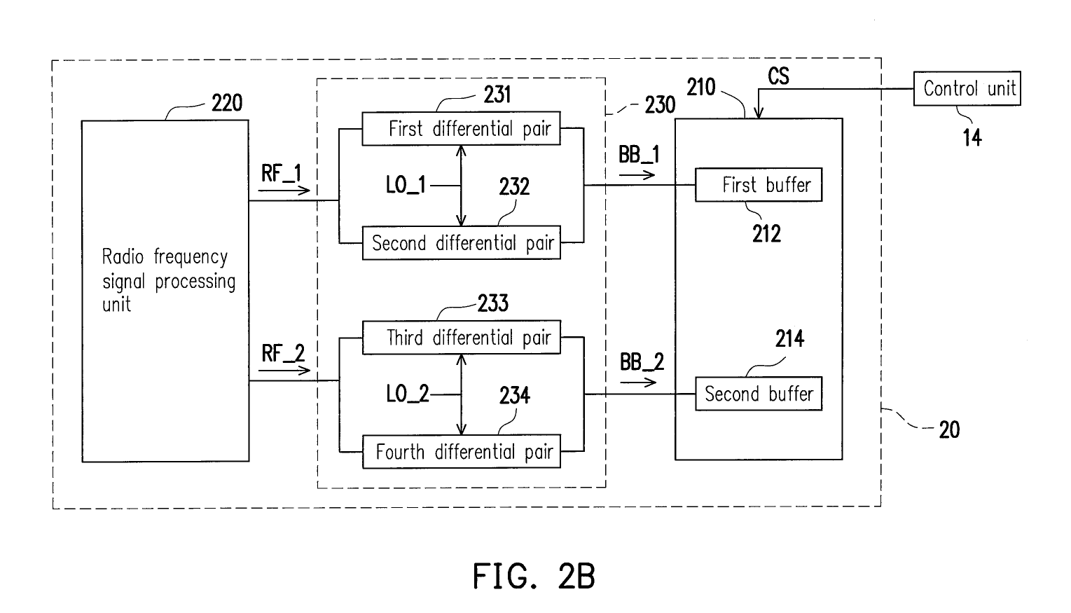

FIG. 2A is a schematic view illustrating a mixer operating in an up-convert mode according to an embodiment of the invention. According to the present embodiment, a mixing unit 230 in a mixer 20 may include a first differential pair 231, a second differential pair 232, a third differential pair 233 and a fourth differential pair 234, which all coupled to a baseband signal processing unit 210 and a radio frequency signal processing unit 220. People skilled in the art should understand that the first differential pair 231, the second differential pair 232 is also referred to as a switch pair. Further, the first differential pair 231, the second differential pair 232, the third differential pair 233 and the fourth differential pair 234 may be assembled to a switching elements (or briefly referred to as a switch quad) composed of four components.

According to the present embodiment, the local oscillation signal LO may include a first oscillation signal LO_1 and a second oscillation signal LO_2, in which a phase difference between the first oscillation signal LO_1 and the second oscillation signal LO_2 is 90 degrees. That is, the first oscillation signal LO_1 and the second oscillation signal LO_2 are mutually orthogonal. The baseband signal BB may include a first component baseband signal BB_1 and a second component baseband signal BB_2, in which a phase difference between the first component baseband signal BB_1 and the second component baseband signal BB_2 is 90 degrees. That is, the first component baseband signal BB_1 and the second component baseband signal BB_2 are mutually orthogonal. The radio frequency signal RF may include a first component radio frequency signal RF_1 and a second component radio frequency signal RF_2, in which a phase difference between the first component radio frequency signal RF_1 and the second radio frequency signal RF_2 is 180 degrees. That is, the first component radio frequency signal RF_1 and the second component radio frequency signal RF_2 are mutually inverse.

The baseband signal processing unit 210 may include a first differential current source 211 and a second differential current source 213. The first differential current source 211 and the second differential current source 213 may refer to as being equivalent to a previous stage baseband circuit of the communication device where the mixer 20 is disposed, the previous baseband circuit may include components for generating the baseband signal, and related description is omitted herein. The first differential current source 211 and the second differential current source 213 are enabled in the up-convert mode, configured to respectively generate the first component baseband signal BB_1 and the second component baseband signal BB_2.

In the up-convert mode of the present embodiment, the first differential pair 231 and the second differential pair 232 may collectively mix the first oscillation signal LO_1 with the first component baseband signal BB_1 to generate the first component radio frequency signal RF_1, and the first component baseband signal RF_1 is outputted to the radio frequency signal processing unit 220. In addition, the third differential pair 233 and the fourth differential pair 234 may collectively mix the second oscillation signal LO_2 with the second component baseband signal BB_2 to generate the second component radio frequency signal RF_2, and the second component radio frequency signal RF_2 is outputted to the radio frequency signal processing unit 220.

FIG. 2B is a schematic view illustrating a mixer operating in a down-convert mode according to an embodiment of the invention. In the present embodiment, the baseband signal processing unit 210 may include a first buffer 212 and a second buffer 214. In the down-convert mode, the first differential pair 231 and the second differential pair 232 may collectively mix the first oscillation signal LO_1 with the first component radio frequency signal RF_1 to generate the first component baseband signal BB_1, and the first component baseband signal BB_1 is outputted to the first buffer 212 of the baseband signal processing unit 210. On the other hand, the third differential pair 233 and the fourth differential pair 234 may collectively mix the second oscillation signal LO_2 with the second component radio frequency signal RF_2 to generate the second component baseband signal BB_2, and the second component baseband signal BB_2 is outputted to the second buffer 214 of the baseband signal processing unit 210.

When the mixer 20 is switched to the up-convert mode according to the control signal CS, the first buffer 212 and the second buffer 214 are enabled to respectively receive the first component baseband signal BB_1 and the second component baseband signal BB_2 and to perform subsequent processes to the first component baseband signal BB_1 and the second component baseband signal BB_2.

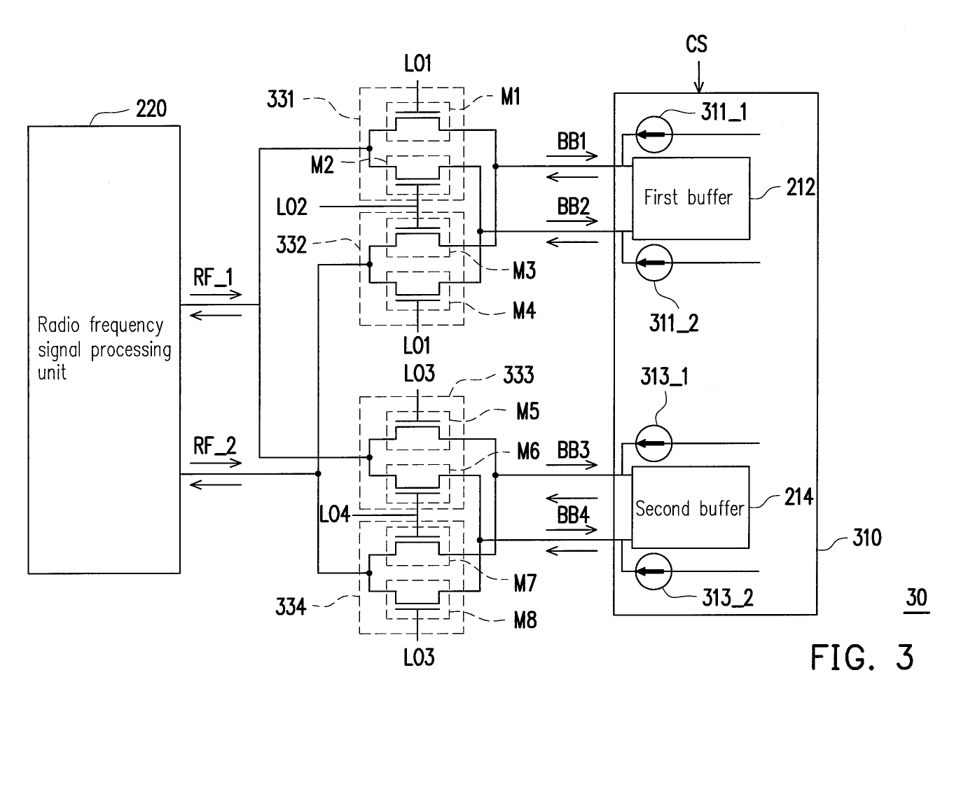

FIG. 3 is a schematic view illustrating a mixer according to an embodiment of the invention. The baseband signal processing unit 310 may include a first current source 311_1, a second current source 311_2, a third current source 313_1, a fourth current source 313_2, the first buffer 212 and the second buffer 214, the operations therein may all be adjusted according to the operating modes of a mixer 30.

According to the present embodiment, the first oscillation signal LO_1 may include a first differential oscillation signal LO1 and a second differential oscillation signal LO2; the second oscillation signal LO_2 may include a third differential oscillation signal LO3 and a fourth differential oscillation signal LO4. In which, a phase difference between the first differential oscillation signal LO1 and the second differential oscillation signal LO2 is 180 degrees; and a phase difference between the third differential oscillation signal LO3 and the fourth differential oscillation signal LO4 is 180 degrees. For instance, when a phase of the first differential oscillation signal LO1 is 0 degree, a phase of the second differential oscillation signal LO2 may be 180 degrees; a phase of the third differential oscillation signal LO3 may be 90 degrees (or 270 degrees); and a phase of the fourth differential oscillation signal LO4 may be 270 degrees (or 90 degrees), which is differ by 180 degrees to the third differential oscillation signal LO3.

Further, the first component baseband signal BB_1 may include a first differential baseband signal BB1 and a second differential baseband signal BB2; the second component baseband signal BB_2 may include a third differential baseband signal BB3 and a fourth differential baseband signal BB4. In which, a phase difference between the first differential baseband signal BB1 and the second differential baseband signal BB2 is 180 degrees; and a phase difference between the third differential baseband signal BB3 and the fourth differential baseband signal BB4 is 180 degrees. For instance, when a phase of the first differential baseband signal BB1 is 0 degree, a phase of the second differential baseband signal BB2 may be 180 degrees; a phase of the third differential baseband signal BB3 may be 90 degrees (or 270 degrees); and a phase of the fourth differential baseband signal BB4 may be 270 degrees (or 90 degrees), which is differ by 180 degrees to the third differential baseband signal BB3.

When the mixer 30 operates in the down-convert mode, the first buffer 212 and the second buffer 214 are enabled according to the control signal CS. Therefore, the first buffer 212 may receive the first differential baseband signal BB1 and the second differential baseband signal BB2 generated by down-converting the first component radio frequency signal RF_1 with the first differential pair 331 and the second differential pair 332. The second buffer 214 may receive the third differential baseband signal BB3 and the fourth differential baseband signal BB4 generated by down-converting the second component radio frequency signal RF_2 with the third differential pair 333 and the fourth differential pair 334.

When the mixer 30 operates in the up-convert mode, the first buffer 212 and the second buffer 214 are disabled according to the control signal CS. Therefore, the first differential pair 331 and the second differential pair 332 respectively receive the first differential baseband signal BB1 from the first current source 311_1 and the second differential baseband signal BB2 from the second current source 311_2. In addition, the third differential pair 333 and the fourth differential pair 334 respectively receive the third differential pair BB3 from the third current source 313_1 and the fourth differential pair BB4 from the fourth current source 313_2.

According to the present embodiment, the first differential pair 331 includes a first transistor M1 and a second transistor M2. The first transistor M1 has a first terminal, a second terminal and a control terminal, in which the first terminal is coupled to the first terminal of the radio frequency signal processing unit 220 to receive or output the first component radio frequency signal RF_1; the second terminal is coupled to a first input terminal of the first buffer 212 or the first current source 311_1 to receive or output the first differential baseband signal BB1; and the control terminal is configured to receive the first differential oscillation signal LO1. The second transistor M2 has a first terminal, a second terminal and a control terminal, in which the first terminal of the second transistor M2 is coupled to the first terminal of the first transistor M1 to receive or output the first component radio frequency signal RF_1; the second terminal is coupled to a second input terminal of the first buffer 212 or the second current source 311_2 to receive or output the second differential baseband signal BB2; and the control terminal is configured to receive the second differential oscillation signal LO2.

The second differential pair 332 includes a third transistor M3 and a fourth transistor M4. The third transistor M3 has a first terminal, a second terminal and a control terminal, in which the first terminal is coupled to the second terminal of the radio frequency signal processing unit 220 to receive or output the second component radio frequency signal RF_2; the second terminal is coupled to the second terminal of the first transistor M1 to receive or output the first differential baseband signal BB1; and the control terminal is configured to receive the second differential oscillation signal LO2. The fourth transistor M4 has a first terminal, a second terminal and a control terminal, in which the first terminal is coupled to the first terminal of the third transistor M3 to receive or output the second component radio frequency signal RF_2; the second terminal is coupled to the second terminal of the second transistor M2 to receive or output the second differential baseband signal BB2; and the control terminal is configured to receive the first differential oscillation signal LO1.

The third differential pair 333 includes a fifth transistor M5 and a sixth transistor M6. The fifth transistor M5 has a first terminal, a second terminal and a control terminal, in which the first terminal is coupled to the first terminal of the radio frequency signal processing unit 220 to receive or output the first component radio frequency signal RF_1; the second terminal is coupled to a first input terminal of the second buffer 214 or the third current source 313_1 to receive or output the third differential baseband signal BB3; and the control terminal is configured to receive the third differential oscillation signal LO3. The sixth transistor M6 has a first terminal, a second terminal and a control terminal, in which the first terminal is coupled to the first terminal of the fifth transistor M5 to receive or output the first component radio frequency signal RF_1; the second terminal is coupled to a second input terminal of the second buffer 214 or the fourth current source 313_2 to receive or output the fourth differential baseband signal BB4; and the control terminal is configured to receive the fourth differential oscillation signal LO4.

The fourth differential pair 334 includes a seventh transistor M7 and an eighth transistor M8. The seventh transistor M7 has a first terminal, a second terminal and a control terminal, in which the first terminal is coupled to the second terminal of the radio frequency signal processing unit 220 to receive or output the second component radio frequency signal RF_2; the second terminal is coupled to a second terminal of the fifth transistor M5 to receive or output the third differential baseband signal BB3; and the control terminal is configured to receive the fourth differential oscillation signal LO4. The eighth transistor M8 has a first terminal, a second terminal and a control terminal, in which the first terminal is coupled to the first terminal of the seventh transistor M7 to receive or output the second component radio frequency signal RF_2; the second terminal is coupled to the second terminal of the sixth transistor M6 to receive or output the fourth differential baseband signal BB4; and the control terminal is configured to receive the third differential oscillation signal LO3.

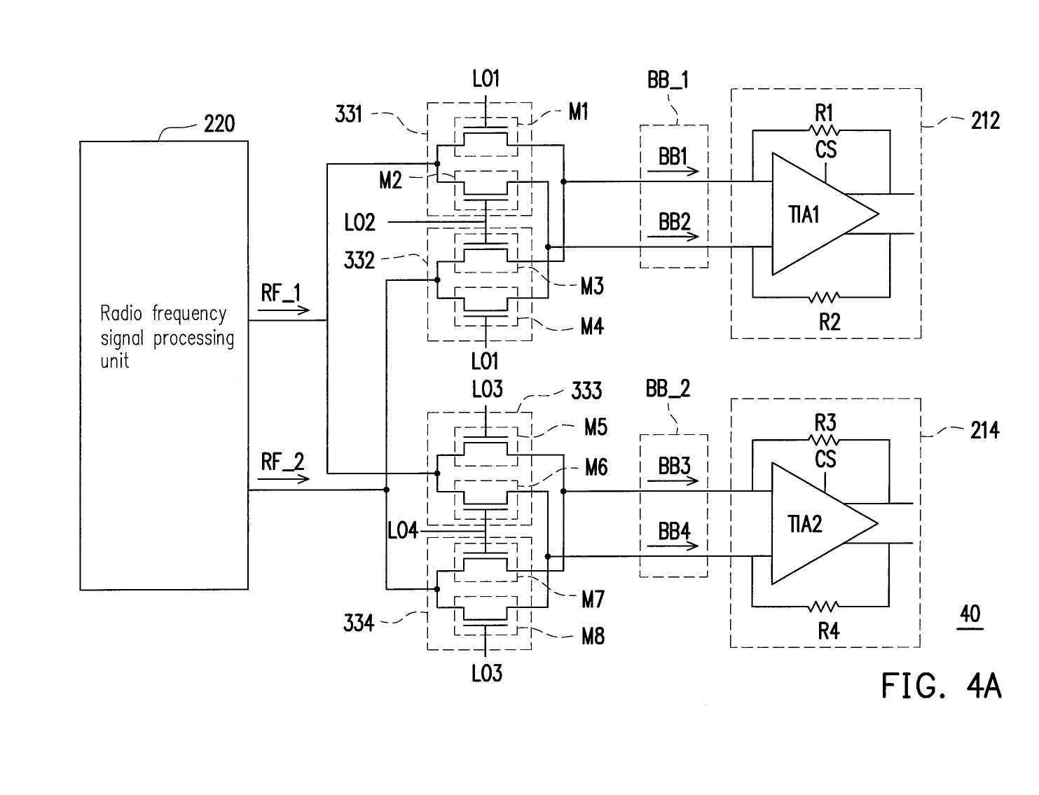

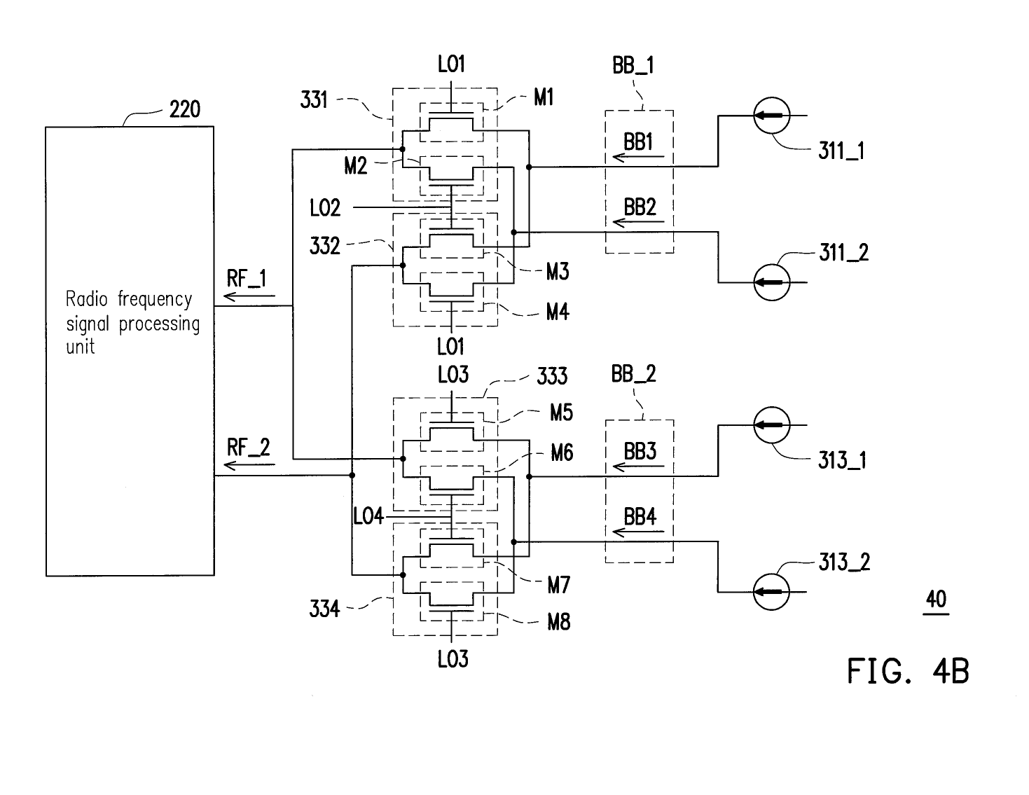

FIG. 4A is a schematic view illustrating a mixer 40 operating in a down-convert mode according to an embodiment of the invention. In the embodiment, the first buffer 212 may include a first trans-impedance amplifier TIA1, a resistor R1 and a resistor R2. In the first trans-impedance amplifier TIA1, a first input terminal is coupled to the first differential pair 331 and a second input terminal is coupled to the second differential pair 332 to receive the first component baseband signal BB_l. That is, the first input terminal of the first buffer 212 receives the first differential baseband signal BB1 and the second input terminal of the first buffer 212 receives the second differential baseband signal BB2. The resistor R1 and the resistor R2 are coupled in series between the input terminal and an output terminal of the first trans-impedance amplifier TIA1.

The second buffer 214 may include a second trans-impedance amplifier TIA2, a resistor R3 and a resistor R4. In the second trans-impedance amplifier TIA2, a first input terminal is coupled to the third differential pair 333 and a second input terminal is coupled to the fourth differential pair 334 to receive the second component baseband signal BB_2. That is, the first input terminal of the second buffer 214 receives the third differential baseband signal BB3 and the second input terminal of the second buffer 214 receives the fourth differential baseband signal BB4. The resistor R3 and the resistor R4 are coupled in series between the input terminal and an output terminal of the second trans-impedance amplifier TIA2.

In the down-convert mode of the present embodiment, the first buffer 212 and the second buffer 214 may be enabled under control of the control signal CS to receive the first component baseband signal BB_1 and the second component baseband signal BB_2.

FIG. 4B is a schematic view illustrating a mixer operating in an up-convert mode according to an embodiment of the invention. In comparison to the embodiment of FIG. 4A, in the up-convert mode of the present embodiment, the first buffer 212 and the second buffer 214 may be disabled according to the control signal CS, so that first trans-impedance amplifier TIA1 and the second trans-impedance amplifier TIA2 may also be disabled. When the first trans-impedance amplifier TIA1 and the second trans-impedance amplifier TIA2 are disabled, the resistors R1, R2, R3 and R4 are all in an off state. In addition, when the mixer 40 operates in an up-convert mode, the first current source 311_1, the second current source 311_2, the third current source 313_1 and the fourth current source 313_2 may respectively refer to as a baseband circuit component for equivalently generating or providing the first differential baseband signal BB1, the second differential baseband signal BB2, the third differential baseband signal BB3 and the fourth differential baseband signal BB4.

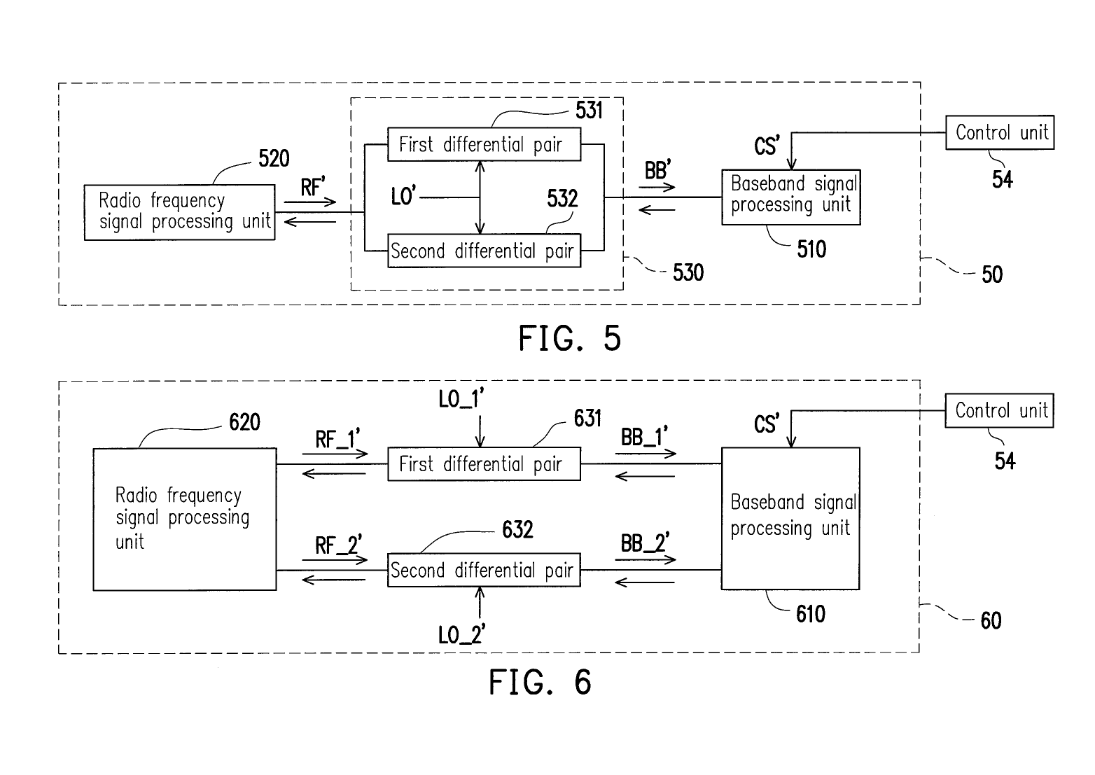

FIG. 5 is a block diagram illustrating a mixer according to an embodiment of the invention. Referring to FIG. 5, a mixer 50 includes a baseband signal processing unit 510, a radio frequency signal processing unit 520, a first differential pair 531 and a second differential pair 532. The mixer 50 has only two differential pairs, in comparison to the embodiment of FIG. 2A, an implementation method of the mixer having four differential pairs may facilitate in balancing a common-mode noise of the local oscillation signal LO. In addition, the baseband signal processing unit 510 and the radio frequency signal processing unit 520 may respectively refer to the baseband signal processing unit 210 and the radio frequency signal processing unit 220 in the embodiment of the FIG. 2A, so related description is omitted herein after. The first differential pair 531 and the second differential pair 532 are respectively coupled to the baseband signal processing unit 510 and the radio frequency signal processing unit 520 and configured to perform the up-convert mixing process or the down-convert mixing process according to a control signal CS′ (sent from a control unit 54 outside of the mixer 50).

When the mixer 50 operates in the up-convert mode, the first differential pair 531 and the second differential pair 532 may collectively mix a baseband signal BB′ with a local oscillation signal LO′ to generate a radio frequency signal RF′, and the radio frequency signal RF′ is outputted to the radio frequency signal processing unit 520 for subsequent processes. The local oscillation signal LO is generated by an oscillating unit (not illustrated in FIG. 5) of a radio frequency front-end circuit of the communication device where the mixer 50 is disposed, the related technical content is omitted herein. On the other hand, when the mixer 50 operates in the down-convert mode, the first differential pair 531 and the second differential pair 532 may collectively mix the radio frequency signal RF′ with the local oscillation signal LO′ to generate the baseband signal BB′, and the baseband signal BB′ is outputted to the baseband signal processing unit 510 for subsequent processes.

In comparison to the embodiments in FIG. 2A and FIG. 2B, the present embodiment only shows two differential pairs, (i.e., the first differential pair 531 and the second differential pair 532), and the mixer 50 may still have capability of performing the up-convert mixing and the down-convert mixing, while reducing the circuit area and manufacturing costs.

FIG. 6 is a block diagram illustrating a mixer according to an embodiment of the invention. According to the present embodiment, the local oscillation signal LO′ includes a first oscillation signal LO_1′ and a second oscillation signal LO_2′; the baseband signal BB′ includes a first component baseband signal BB_1′ and a second component baseband signal BB_2′; and the radio frequency signal RF′ includes a first component radio frequency signal RF_1′ and a second component radio frequency signal RF_2′. In addition, a phase difference between the first oscillation signal LO_1′ and the second oscillation signal LO_2′ is 90 degrees; a phase difference between the first component baseband signal BB_1′ and the second component baseband signal BB_2′ is 90 degrees; and a phase difference between the first component radio frequency signal RF_1′ and the second component radio frequency signal RF_2′ is 180 degrees.

When a mixer 60 operates in the up-convert mode, a first differential pair 631 mixes the first oscillation signal LO_1′ with the first component baseband signal BB_1′ to generate the first component radio frequency signal RF_1′; a second differential pair 632 mixes the second oscillation signal LO_2′ with the second component baseband signal BB_2′ to generate the second component radio frequency signal RF_2′.

When the mixer 60 operates in the down-convert mode, the first differential pair 631 mixes the first oscillation signal LO_1′ with the first component radio frequency signal RF_1′ to generate the first component baseband signal BB_1′; the second differential pair 632 mixes the second oscillation signal LO_2′ with the second component radio frequency signal RF_2′ to generate the second component baseband signal BB_2′.

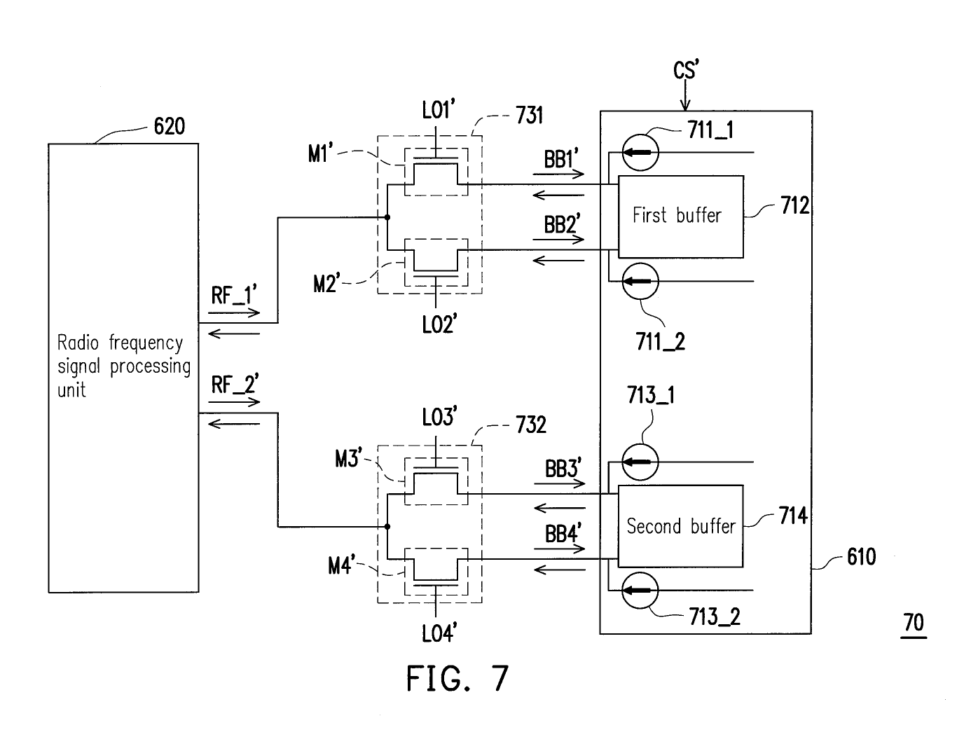

FIG. 7 is a schematic view illustrating a mixer according to an embodiment of the invention. In the embodiment of a mixer 70, the first differential oscillation signal LO_1′ includes a first oscillation signal LO1′ and a second oscillation signal LO2′. The second oscillation signal LO_2′ includes a third oscillation signal LO3′ and a fourth oscillation signal LO4′. The first component baseband signal BB_1′ includes a first differential baseband signal BB1′ and a second differential baseband signal BB2′. The second component baseband signal BB_2′ includes a third differential baseband signal BB3′ and a fourth differential baseband signal BB4′. In addition, a phase difference between the first differential oscillation signal LO1′ and the second differential oscillation signal LO2′ is 180 degrees. A phase difference between the third differential oscillation signal LO3′ and the fourth differential oscillation signal LO4′ is 180 degrees. A phase difference between the first differential baseband signal BB1′ and the second differential baseband signal BB2′ is 180 degrees. A phase difference between the third differential baseband signal BB3′ and the fourth differential baseband signal BB4′ is 180 degrees.

According to the present embodiment, a baseband signal processing unit 610 includes a first current source 711_1, a second current source 711_2, a third current source 713_1, a fourth current source 713_2, the first buffer 712 and the second buffer 714. Detailed description and operating processes of said baseband signal processing unit 610 can be referred to the foregoing embodiment and is thus omitted herein.

A first differential pair 731 includes a first transistor M1′ and a second transistor M2′. The first transistor M1′ has a first terminal, a second terminal and a control terminal, in which the first terminal is coupled to the first terminal of the radio frequency signal processing unit 620 to receive or output the first component radio frequency signal RF_1′; the second terminal is coupled to the first current source 711_1 or a first input terminal of the first buffer 712 to receive or output the first differential baseband signal BB1′; and the control terminal is configured to receive the first differential oscillation signal LO1′. The second transistor M2′ has a first terminal, a second terminal and a control terminal, in which the first terminal is coupled to the first terminal of the first transistor M1′ to receive or output the first component radio frequency signal RF_1′; the second terminal is coupled to the second current source 711_2 or a second input terminal of the first buffer 712 to receive or output the second differential baseband signal BB2′; and the control terminal is configured to receive the second differential oscillation signal LO2′.

The second differential pair 732 may include a third transistor M3′ and a fourth transistor M4′. The third transistor M3′ has a first terminal, a second terminal and a control terminal, in which the first terminal is coupled to the second terminal of the radio frequency signal processing unit 620 to receive or output the second component radio frequency signal RF_2′; the second terminal is coupled to the third current source 713_1 or a first input terminal of the second buffer 714 to receive or output the third differential baseband signal BB3′; and the control terminal is configured to receive the third differential oscillation signal LO3′. The fourth transistor M4′ has a first terminal, a second terminal and a control terminal, in which the first terminal is coupled to the first terminal of the third transistor M3′ to receive or output the second component radio frequency signal RF_2′; the second terminal is coupled to the fourth current source 713_2 or a second input terminal of the second buffer 714 to receive or output the fourth differential baseband signal BB4′; and the control terminal is configured to receive the fourth differential oscillation signal LO4′.

When the mixer 70 operates in the down-convert mode, the first buffer 712 and the second buffer 714 may be enabled under control of the control signal CS, which then used for receiving the first component baseband signal BB_1′ and the second component baseband signal BB_2′. That is, for the first buffer 712, in which the first terminal receives the first differential baseband signal BB1′, and the second terminal receives the second differential baseband signal BB2′; for the second buffer 712, in which the first terminal receives the third differential baseband signal BB3′, and the second terminal receives the fourth differential baseband signal BB4′.

When the mixer 70 operates in the up-convert mode, the first buffer 712 and the second buffer 714 may be disabled according to the control signal CS. Therefore, the first differential pair 731 receives the first differential baseband signal BB1′ and the second differential baseband signal BB2′ respectively from the first current source 711_1 and the second current source 711_2; the second differential pair 732 receives the third differential baseband signal BB3′ and the fourth differential baseband signal BB4′ respectively from the third current source 713_1 and the fourth current source 713_2.

In view of above, according to the embodiments of the invention, a mixer having a single mixing unit for switching to an up-convert mode or a down-convert mode according to an external control signal is provided. When the mixer operates in the up-convert mode, the mixing unit may perform an up-convert mixing to a baseband signal and a local oscillation signal outputted from a baseband signal processing unit, so as to up-convert the baseband signal to a radio frequency signal, and the radio frequency signal is outputted to a radio frequency signal processing unit for subsequent processes. When the mixer operates in the down-convert mode, the mixing unit may perform a down-convert mixing to a radio frequency signal and a local oscillation signal outputted from a radio frequency signal processing unit of a next stage, so as to down-convert the radio frequency signal to a baseband signal, and the baseband signal is outputted to a baseband signal processing unit of a next stage for subsequent processes. Since the same mixing unit is used for both up-convert mixing and down-convert mixing, circuit area occupied by the mixer may be reduced and the manufacturing costs of the communication apparatus having said mixer may also be reduced.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A mixer, comprising:
a baseband signal processing unit, receiving or generating a baseband signal;
a radio frequency signal processing unit, processing or outputting a radio frequency signal; and
a mixing unit, coupled to the baseband signal processing unit and the radio frequency signal processing unit, selecting and operating in an up-convert mode or a down-convert mode according to a control signal;
wherein, when the mixer operates in the up-convert mode, the mixing unit mixes the baseband signal with the local oscillation signal to generate the radio frequency signal and outputs the radio frequency signal to the radio frequency signal processing unit; and
when the mixer operates in the down-convert mode, the mixing unit mixes the radio frequency signal with the local oscillation signal to generate the baseband signal and outputs the baseband signal to the baseband signal processing unit.

2. The mixer of claim 1, wherein:
the local oscillation signal comprises a first oscillation signal and a second oscillation signal, wherein a phase difference between the first oscillation signal and the second oscillation signal is 90 degrees; the baseband signal comprises a first component baseband signal and a second component baseband signal, wherein a phase difference between the first component baseband signal and the second component baseband signal is 90 degrees; and the radio frequency signal comprises a first component radio frequency signal and a second component radio frequency signal, wherein a phase difference between the first component radio frequency signal and the second component radio frequency signal is 180 degrees.

3. The mixer of claim 2, wherein the mixing unit comprises a first differential pair, a second differential pair, a third differential pair and a fourth differential pair, respectively coupled to the radio frequency signal processing unit and the radio frequency signal processing unit, wherein in the up-convert mode,
the first differential pair and the second differential pair collectively mix the first oscillation signal with the first component baseband signal to generate the first component radio frequency signal; and
the third differential pair and the fourth differential pair collectively mix the second oscillation signal with the second component baseband signal to generate the second component radio frequency signal.

4. The mixer of claim 3, wherein in the down-convert mode,
the first differential pair and the second differential pair collectively mix the first oscillation signal with the first component radio frequency signal to generate the first component baseband signal, and the first component baseband signal is outputted to a first buffer of the baseband signal processing unit; and
the third differential pair and the fourth differential pair collectively mix the second oscillation signal with the second component radio frequency signal to generate the second component baseband signal, and the second component baseband signal is outputted to a second buffer of the baseband signal processing unit.

5. The mixer of claim 4, wherein the first oscillation signal comprises a first differential oscillation signal and a second differential oscillation signal, and a phase difference between the first differential oscillation signal and the second differential oscillation signal is 180 degrees; and the first component baseband signal comprises a first differential baseband signal and a second differential baseband signal, and a phase difference between the first differential baseband signal and the second differential baseband signal is 180 degrees, the first differential pair comprises:
a first transistor having a first terminal, a second terminal and a control terminal, wherein the first terminal of the first transistor is configured to receive or output the first component radio frequency signal; the second terminal of the first transistor is configured to receive or output the first differential baseband signal; and the control terminal of the first transistor is configured to receive the first differential oscillation signal; and
a second transistor having a first terminal, a second terminal and a control terminal, wherein the first terminal of the second transistor is coupled to the first terminal of the first transistor to receive or output the first component radio frequency signal; the second terminal of the second transistor is configured to receive or output the second differential baseband signal; and the control terminal of the second transistor is configured to receive the second differential oscillation signal.

6. The mixer of claim 5, wherein the second differential pair comprises:
a third transistor having a first terminal, a second terminal and a control terminal, wherein the first terminal of the third transistor is configured to receive or output the second component radio frequency signal; the second terminal of the third transistor is coupled to the second terminal of the first transistor to receive or output the first differential baseband signal; and the control terminal of the third transistor is configured to receive the second differential oscillation signal; and
a fourth transistor having a first terminal, a second terminal and a control terminal, wherein the first terminal of the fourth transistor is coupled to the first terminal of the third transistor to receive or output the second component radio frequency signal; the second terminal of the fourth transistor is coupled to the second terminal of the second transistor to receive or output the second differential baseband signal; and the control terminal of the fourth transistor is configured to receive the first differential oscillation signal.

7. The mixer of claim 4, wherein the second oscillation signal comprises a third differential oscillation signal and a fourth differential oscillation signal, and a phase difference between the third differential oscillation signal and the fourth differential oscillation signal is 180 degrees; and the second component baseband signal comprises a third differential baseband signal and a fourth differential baseband signal, and a phase difference between the third differential baseband signal and the fourth differential baseband signal is 180 degrees, the third differential pair comprises:
a fifth transistor having a first terminal, a second terminal and a control terminal, wherein the first terminal of the fifth transistor is configured to receive or output the first component radio frequency signal; the second terminal of the fifth transistor is configured to receive or output the third differential baseband signal; and
the control terminal of the fifth transistor is configured to receive the third differential oscillation signal; and
a sixth transistor having a first terminal, a second terminal and a control terminal, wherein the first terminal of the sixth transistor is coupled to the first terminal of the fifth transistor to receive or output the first component radio frequency signal; the second terminal of the sixth transistor is configured to receive or output the fourth differential baseband signal; and the control terminal of the sixth transistor is configured to receive the fourth differential oscillation signal.

8. The mixer of claim 7, wherein the fourth differential pair comprises:
a seventh transistor having a first terminal, a second terminal and a control terminal, wherein the first terminal of the seventh transistor is configured to receive or output the second component radio frequency signal; the second terminal is coupled to the second terminal of the seventh transistor of the fifth transistor to receive or output the third differential baseband signal; and the control terminal of the seventh transistor is configured to receive the fourth differential oscillation signal; and
an eighth transistor having a first terminal, a second terminal and a control terminal, wherein the first terminal of the eighth transistor is coupled to the first terminal of the seventh transistor to receive or output the second component radio frequency signal; the second terminal of the eighth transistor is coupled to the second terminal of the sixth transistor to receive or output the fourth differential baseband signal; and the control terminal of the eighth transistor is configured to receive the third differential oscillation signal.

9. The mixer of claim 4, wherein the first buffer comprises:
a first trans-impedance amplifier, coupled to the first differential pair and the second differential pair, having an input terminal for receiving the first component baseband signal, wherein when the mixer operates in the up-convert mode, the first trans-impedance amplifier is disabled according to the control signal; and
at least one resistor, coupled to the input terminal and an output terminal of the first trans-impedance amplifier.

10. The mixer of claim 4, wherein the first buffer comprises:
a second trans-impedance amplifier, coupled to the third differential pair and the fourth differential pair, having an input terminal for receiving the second component baseband signal, wherein when the mixer operates in the up-convert mode, the second trans-impedance amplifier is disabled according to the control signal; and
at least one resistor, coupled to the input terminal and an output terminal of the second trans-impedance amplifier.

11. A mixer, comprising:
a baseband signal processing unit, receiving or generate a baseband signal;
a radio frequency signal processing unit, processing or outputting a radio frequency signal;
a first differential pair and a second differential pair, respectively coupled to the baseband signal processing unit and the radio frequency signal processing unit and configured to perform an up-convert mixing process or a down-convert mixing process according to a control signal; and
wherein, when the mixer operates in the up-convert mode, the first differential pair and the second differential pair collectively mix the baseband signal with the local oscillation signal to generate the radio frequency signal and output the radio frequency signal to the radio frequency signal processing unit; and when the mixer operates in the down-convert mode, the first differential pair and the second differential pair collectively mix the radio frequency signal with the local oscillation signal to generate the baseband signal and output the baseband signal to the baseband signal processing unit.

12. The mixer of claim 11, wherein the local oscillation signal comprises a first oscillation signal and a second oscillation signal; the baseband signal comprises a first component baseband signal and a second component baseband signal; and the radio frequency signal comprises a first component radio frequency signal and a second component radio frequency signal, wherein in the up-convert mode,
the first differential pair mixes the first oscillation signal with the first component baseband signal to generate the first component radio frequency signal; and
the second differential pair mixes the second oscillation signal with the second component baseband signal to generate the second component radio frequency signal.

13. The mixer of claim 12, wherein in the down-convert mode,
the first differential pair mixes the first oscillation signal with the first component radio frequency signal to generate the first component baseband signal, and the first component baseband signal is outputted to the baseband signal processing unit; and
the second differential pair mixes the second oscillation signal with the second component radio frequency signal to generate the second component baseband signal, and the second component baseband signal is outputted to the baseband signal processing unit.

14. The mixer of claim 13, wherein a phase difference between the first oscillation signal and the second oscillation signal is 90 degrees; a phase difference between the first component baseband signal and the second component baseband signal is 90 degrees; and a phase difference between the first component radio frequency signal and the second component radio frequency signal is 180 degrees.

15. The mixer of claim 13, wherein the first oscillation signal comprises a first differential oscillation signal and a second differential oscillation signal; and the first component baseband signal comprises a first differential baseband signal and a second differential baseband signal, wherein the first differential pair comprises:
a first transistor having a first terminal, a second terminal and a control terminal, wherein the first terminal of the first transistor is configured to receive or output the first component radio frequency signal; the second terminal of the first transistor is configured to receive or output the first differential baseband signal; and the control terminal of the first transistor is configured to receive the first differential oscillation signal; and
a second transistor having a first terminal, a second terminal and a control terminal, wherein the first terminal of the second transistor is coupled to the first terminal of the first transistor to receive or output the first component radio frequency signal; the second terminal of the second transistor is configured to receive or output the second differential baseband signal; and the control terminal of the second transistor is configured to receive the second differential oscillation signal.

16. The mixer of claim 15, wherein the second oscillation signal comprises a third differential oscillation signal and a fourth differential oscillation signal; and the second component baseband signal comprises a third differential baseband signal and a fourth differential baseband signal; wherein the second differential pair comprises:
a third transistor having a first terminal, a second terminal and a control terminal, wherein the first terminal of the third transistor is configured to receive or output the second component radio frequency signal; the second terminal of the third transistor is configured to receive or output the third differential baseband signal; and the control terminal of the third transistor is configured to receive the third differential oscillation signal; and
a fourth transistor having a first terminal, a second terminal and a control terminal, wherein the first terminal of the fourth transistor is coupled to the first terminal of the third transistor to receive or output the second component radio frequency signal; the second terminal of the fourth transistor is configured to receive or output the fourth differential baseband signal; and the control terminal of the fourth transistor is configured to receive the fourth differential oscillation signal.

17. The mixer of claim 15, wherein a phase difference between the first differential oscillation signal and the second differential oscillation signal is 180 degrees, and a phase difference between the first differential baseband signal and the second differential baseband signal is 180 degrees.

18. The mixer of claim 16, wherein a phase difference between the third differential oscillation signal and the fourth differential oscillation signal is 180 degrees, and a phase difference between the third differential baseband signal and the fourth differential baseband signal is 180 degrees.
